(19) United States
(12) Patent Application Publication
(10) Pub. No.: US 2014/0354535 A1
(43) Pub. Date: Dec. 4, 2014

(54) SYSTEM AND METHOD OF DISPLAY DEVICE

(71) Applicants: TAI-JAN CHEN, New Taipei City (TW); SHOU-MEI XIE, New Taipei City (TW); YI-JAN CHEN, Erbach (DE)

(72) Inventors: TAI-JAN CHEN, New Taipei City (TW); STEPHAN AHLES, Erbach (DE)

(73) Assignees: TAI-JAN CHEN, New Taipei City (TW); YI-JAN CHEN, Erbach (DE); SHOU-MEI XIE, New Taipei City (TW)

(21) Appl. No.: 14/013,027

(22) Filed: Aug. 28, 2013

(30) Foreign Application Priority Data
May 31, 2013 (TW) 102119346

(51) Int. Cl. G09G 5/00; G09G 5/37; G06F 3/01

(52) U.S. Cl. CPC G09G 5/003; G06F 3/011; G09G 5/37
USPC 345/156

(57) ABSTRACT

The invention proposes a system and method of a display device. When the distance between a user and the display device is too close or far, or the angle between the user and the display device slants too much, the display device sends out a command to inform the user to adjust the user's position while watching the display device. A method for the display device comprises following steps: a detecting device and an operating system calculating a relative position between the user and the display device, the operating system generating an warning command according to the relative position, a warning module receiving the warning command and afterward sending out the command, the command being sent to a display module, a motion-generating device and an audio device.

### BACKGROUND OF THE INVENTION

1. Field the Invention

The present invention relates to a display device and the method thereof, more particularly to a display device with a function to detect the distance and the angle between a user and the display device.

2. Description of Related Art

If a user gets too close to a screen while watching television, muscles of the eyes of the user must adjust to gain clear images. After a long-term watching, it could cause the muscles fatigue, children's visual acuity deterioration and for elderly people, their eyes are less sensible to adjust the focus and the secretion of tear, then, there is a possibility that the fatigue could cause cataract.

According to a granted patent I361979 in Taiwan, a notebook computer is able to detect the distance between it and a user because of an infrared sensor which is configured on the LED display. When the distance between the user and the LED display is in a range of predetermined distance, the infrared sensor generates a trigger signal which can be a specific signal and an alarm sound.

Only does the user get too close to the LED display, the user is informed by the alarm sound or a specific signal in the prior art. In general, getting too close to the LED display is not the only reason for users' eyes to get fatigue or to feel uncomfortable.

### SUMMARY OF THE INVENTION

The present invention demonstrates a display device with a function to detect a distance and an angle between a user and the display device. The display device comprises a detecting device, an operating system, a warning module, an internet interface, a display module, an audio device, and a motion-generating device. The detecting device detects a position indicator which specifies a distance between a user and the display device. The operating system is connected with the detecting device and is able to calculate a relative position between the user and the display device according to the position indicator received by the operating system; therefore, the operating system is able to generate and transmit a warning command to a warning module. The warning module is connected to the operating system to receive the warning command and is able to generate and transmit a command to the display module. The display module is connected to the warning module and is able to receive and execute the command; the command is an obstruction command. The obstruction command is able to interrupt a screen displaying on the display module or is able to cover the screen displaying on the display module with a picture, words, or the combination thereof. The present invention can dissolve the described defect not only warnings for the user for the short distance with the LED display; but also warnings for the user for the wrong angle with the LED display. The operating method of the display device comprises following steps: (a) the detecting device of a display device detecting a position indicator between the user and the display device; (b) the detecting device transmitting the position indicator to the operating system; (c) the operating system receiving the position indicator and calculating a relative position between the user and the display device; (d) the operating system generating the warning command or returning to the step (a); (e) after receiving the warning command, the warning module generating and transmitting a command. An operating software for the display device to operate is installed on the display device by ways of being built-in, down loading from internet, from Universal Serial Bus (USB), or by Local Area Network (LAN) sharing. The user can choose to start or to close the operating software which is protected by a code. The command as an obstruction command can interrupt a screen displayed on a display module or able to cover the screen displayed on the display module with a picture, words, or the combination thereof.

The present invention utilizes the detecting device and the operating system to calculate the relative position of the user and the display device. If the distance between the user and the display device exceed a predetermined value, the warning command is generated. The warning command is received by the warning module and then a command is generated. The command can be an obstruction command, or is further for motion generating, for turning off, for a sound effect for an image effect, or the combination thereof. The image effect can be the effect of turning the screen displayed on the display module into one colour. The user can keep a proper distance or a proper angle to the display device according to the command.

Therefore, the present invention demonstrating the display device and the operating method to operate, the display device with the ability to detect a distance and an angle can remind the user not only the distance but also the angle between the user and the display device; moreover, the ways to notify the user can be different. The display device can be a mobile phone, a television, a monitor or any other type of display device.

### BRIEF DESCRIPTION OF THE DRAWINGS

FIG. 1 illustrates the block diagram of the present invention.

FIG. 2 illustrates the flow chart of the present invention.

FIG. 3 illustrates the relative position between the user and the display device.

### DETAILED DESCRIPTION OF THE INVENTION

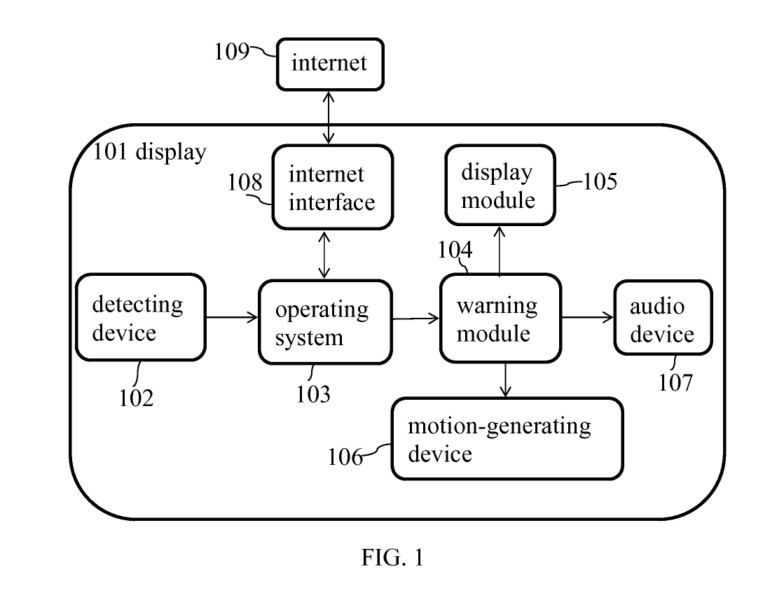

FIG. 1 illustrates the block diagram of the present invention. The display device with an ability to detect a distance and an angle between a user and the display device 101, in the present invention comprises a detecting device 102, an operating system 103, a warning module 104, a display module 105, a motion-generating device 106, an audio device 107, and an internet interface 108. The display module 105 can be a mobile phone, a television, a monitor or any other type of display device.

The detecting device 102 can be a video scanner, a camera, or any other type of image receiver and comprises an image-detecting device and a sound-detecting device. The image-detecting device is able to detect motion and position of a user and to constantly receive image singles for determining whether the user is watching the display device 101. The image-detecting device can be Complementary metal-oxide-semiconductor (CMOS) sensor, Charge-coupled Device (CCD) sensor, or infrared sensor. The sound-detecting device is able to detect sound and to constantly receive sound signals for determining whether the user is watching the display device 101. The sound-detecting device can be a sound receiver, audio power amplifier. After the display device 101 turns on, the function of the motion and the sound detection of the detecting device 102 can be turned on first, then follow by the function of position detection. When the user is moving, the detecting device 102 can detect the movement and generate a motion indicator; when the user makes a sound, the detecting device 102 can detect the sound and generate a sound indicator. The detecting device 102 can determine whether the user is watching the display device 101 according to the motion indicator or the sound indicator. If the detecting device 102 determines the user is watching the display device 101, the detecting device 102 activates the function of the position detection and then generates a position indicator.

The operating system 103 is connected to the detecting device 102. The operating system 103 can receive the position indictor and then calculate a relative position between the user and the display device 101. The relative position can be an angle 111 or a distance 110 between the user and the display device 101. When the angle or the distance between the user and the display device 101 exceed a predetermined value, a warning command is generated and able to be transmitted to the warning module 104 by the operating system 103. The predetermined value can be double or triple of the screen diagonal of the screen displayed on the display module 105 or the predetermined value can be in the range of 0 degree (0°) to 25 degrees (25°) of normal vector of the user and a plane of the display device 101. The internet interface 108 and the operating system 103 are connected to an internet 109. The internet interface 108 makes the display device 101 connected to the internet 109. The operating system 103 can be a central processor.

The warning module 104 is connected to the operating system 103 to receive the warning command and to generate and transmit a command to the display module 105. The warning module 104 can be a computing chip for generating and transmitting the command according to the warning command or a software or an application.

The command can be an obstruction command, or is further for motion generating, to turn it off, for a sound effect, for an image effect, or the combination thereof. The image effect can be the effect of turning the screen displayed on the display module into one colour. The display module 105 is connected to the warning module 104. The obstruction command is able to interrupt a screen which is being displayed on the display module 105 or able to cover the screen being displayed on the display module 105 with a picture, words, or the combination thereof. The obstruction command can make the screen being displayed on the display module 105 vibrated, turned into one colour (e.g. black or white). The command for turning off is transmitted to the display module 105 and the screen of the display module 105 is turned off. The motion-generating device 106 is connected to the warning module 104. The command for motion generating is able to control the motion-generating device 106 to make the display device 101 vibrated. For example, when the user is getting to close to a smart phone, the smart phone can generate vibration to notify the user. The command for the sound effect is able to make the audio device 107 of the display device 101 generate a sound, the sound can be a siren tone, a bell tone, a vocal file, which can be recorded by the user, or a music file, which can be a piece of music. The audio device 107 can be speakers, stereos, loudspeakers, or an amplifier.

The distance 110 and the angle 111 of the predetermined value can be determined by the user. The value of the distance 110 can be distinguished into three ranges, for example, short distance (small angle), adequate distance (proper angle), or long distance (large angle) between the user and the display device 101. When the user is getting too close to the display device 101, the obstruction command generated can notify the user of the short distance, therefore, the eyes of the user can be protected. When the distance 101 between the user and the display device 101 is beyond the predetermined value, the command generated can make the screen displaying on the display module 105 turning into one colour (e.g. black or white), therefore, the display device 101 command can serve the function of an anti-peeping. On the contrary, when the distance 101 between the user and the display device 101 is beyond the predetermined value, after a predetermined time, the command can be generated and turn off the screen for energy saving, when the distance 111 between the user and the distance 101 is back into the adequate distance, the command for turning off will be canceled, so is the energy saving function.

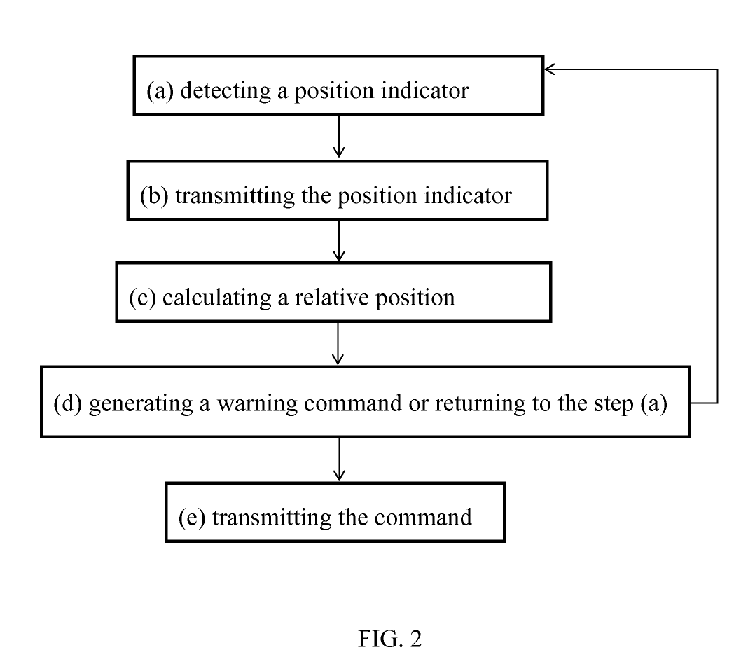

The FIG. 2 illustrates the flow chart of the display device 101 with the ability to detect a distance and an angle between a user and the display device the present invention: (a) detecting a position indicator: the detecting device 102 of the display device 101 detecting the motion indicator and the sound indicator between the user and the display device 101, whether the position indicator is generated according to the motion indicator and the sound indicator; (b) transmitting the position indicator: the detecting device 102 transmitting the position indicator to the operating system 103; (c) calculating the relative position: the operating system 103 receiving the position indicator and calculating the relative position between the user and the display device 101; (d) generating the warning command or returning to the step (a): the operating system 103 generating the warning command or returning to the step (a) according to the relative position; (e) transmitting the command: after receiving the warning command, the warning module 104 generating and transmitting the command. An operating software for the display device 101 to operate can be installed on the display device 101 by ways of being built-in, down loading from internet or from Universal Serial Bus (USB), or by Local Area Network (LAN) sharing. The user is able to choose to start or to close the operating software protected by a code which is set up by the user.

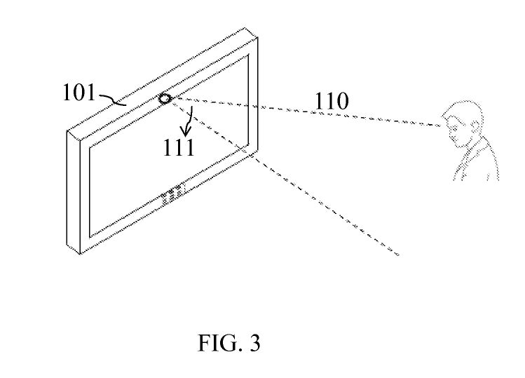

FIG. 3 illustrates the relative position between the user and the display device 101. The predetermined value can be double or triple of the screen diagonal of the screen displayed on the display module, moreover, the predetermined value can also be in the range of 0 degree (0°) to 25 degrees (25°) of normal vector of the user and the plane of the display device 101. When the display device 101 detects the distance 110 between the user and the is beyond the triple but within the double of the screen diagonal of the screen being displayed on the display module 105, or is over the range of 25 degrees (25°) of normal vector of the user and the plane of the display device 101, the command is generated to notify the user to adjust the distance 110 or the angle 111 between the user and the display device 101. The image-detecting device can also be an infrared sensor which is able to detect the 0° to 85° range of the normal vector of the display device 101 or is able to detect the zero to decuple of the screen diagonal of the screen being displayed on the display module 105. If the angle 111 of the normal vector between the user and the plane of the display device 101 is 50°, which is beyond the predetermined value and the predetermined time for keeping 50° is over, which can be 20 seconds, the warning command is transmitted, and then a command for turning off is generated and transmitted, consequently, the screen of the display module 105 is turning off. If the sound-detecting device detects the sound from the user who is in the one and a half times rang of the screen diagonal of the screen displayed on the display module 105 and the predetermined time is over 20 seconds, the warning command is transmitted, and then a command for turning off is generated and transmitted, consequently, the screen of the display module 105 is turning off.

What is claimed is:

1. A display device with a function to detect a distance and an angle between a user and the display device comprising:
a detecting device detecting a position indicator between the user and the display device;
an operating system connected with the detecting device to calculate a relative position between the user and the display device according to the position indicator received by the operating system and to generate and transmit a warning command;
a warning module connected to the operating system to receive the warning command and to generate and transmit a command; and
a display module connected to the warning module to receive and execute the command, the command as an obstruction command;
wherein the obstruction command able to interrupt a screen being displayed on the display module or able to cover the screen displaying on the display module with a picture, words, or the combination thereof.

2. The display device claimed in claim 1, wherein the detecting device further detects a motion indicator and a sound indicator between the user and the display device.

3. The display device claimed in claim 1, wherein the relative position is an angle or a distance.

4. The display device claimed in claim 1, wherein the operating system is connected to an internet interface.

5. The display device claimed in claim 1, wherein the display device is a mobile phone, a television, a monitor or any other type of display.

6. The display device claimed in claim 1, wherein the detecting device is a video scanner, a camera or any other type of image receiver.

7. The display device claimed in claim 1, wherein the operating system is a central processor.

8. The display device claimed in claim 1, wherein the warning module is a computing chip for generating the command according to the warning command or a software or an application.

9. The display device claimed in claim 1, wherein the command is further for motion generating, for turning off, or for a sound effect, for an image effect, or the combination thereof.

10. The display device claimed in claim 9, wherein the command for turning off is transmitted to the display module and the screen of the display module is turned off.

11. The display device claimed in claim 9, wherein the command for motion generating is able to control a motion-generating device to make the display device vibrated, the motion-generating device connected to the warning module.

12. The display device claimed in claim 9, wherein the command for sound effect is able to make an audio device generated a sound, the sound being a siren tone, a bell tone, a vocal file, or a music file, the audio device connected to the warning module.

13. A method for operating a display device with an ability to detect a distance and an angle between a user and the display device comprising steps of:
(a) a detecting device of a display device detecting a position indicator specifying a distance between a user and the display device;
(b) the detecting device transmitting the position indicator to an operating system;
(c) the operating system receiving the position indicator and calculating a relative position between the user and the display device;
(d) the operating system generating a warning command or returning to the step (a);
(e) after receiving the warning command, a warning module generating and transmitting a command;
an operating software for the display device to operate installed on the display device by ways of being built-in, downloading from internet or from Universal Serial Bus (USB), or by Local Area Network (LAN) sharing, the user able to choose to start or to close the operating software protected by a code, the command as an obstruction command; the obstruction command able to interrupt a screen being displayed on a display module or able to cover the screen displayed on the display module with a picture, words, or the combination thereof.

14. The method claimed in claim 13, wherein the detecting device in the step (a) detects a motion indicator and a sound indicator between the user and the display device.

15. The method claimed in claim 13, wherein the relative position in the step (c) is an angle or a distance.

16. The method claimed in claim 13, wherein the warning command in the step (d) is generated by the operating system as the angle or the distance between the user and the display device exceed a predetermined value.

17. The method claimed in claim 16, wherein the predetermined value is double or triple of the screen diagonal of the screen displayed on the display module.

18. The method claimed in claim 16, wherein the predetermined value is in the range of 0 degree (0°) to 25 degrees (25°) of normal vector of the user and the plane of the display device.

19. The method claimed in claim 13, wherein the obstruction command makes the screen displayed on the display module vibrated, turned into one colour.

20. The method claimed in claim 13, wherein the command in the step (e) is for a motion generating, for turning off, for a sound effect, for an image effect, or the combination thereof.
